(19) United States
(12) Patent Application Publication
(10) Pub. No.: US 2023/0207148 A1
(43) Pub. Date: Jun. 29, 2023

(54) CHARGEABLE ATOMIC BATTERY WITH PRE-ACTIVATION ENCAPSULATION MANUFACTURING

(71) Applicant: Ultra Safe Nuclear Corporation, Seattle, WA (US)

(72) Inventors: Christopher Morrison, Seattle, WA (US); Paolo Francesco Venneri, Seattle, WA (US); Michael John Eades, Seattle, WA (US); Sarah Yue, Seattle, WA (US)

(21) Appl. No.: 17/787,764

(22) PCT Filed: Feb. 7, 2021
(86) PCT No.: PCT/US2021/016980

§ 371 Date: Jun. 21, 2022

Related U.S. Application Data
(60) Provisional application No. 62/971,898, filed on Feb. 7, 2020.

(51) Int. Cl. G21H 1/00; G21F 5/015

(52) U.S. Cl. CPC G21H 1/00; G21F 5/015; G21G 1/02

(57) ABSTRACT

A chargeable atomic battery (CAB) and a standardized pre-irradiation encapsulation manufacturing method. A CAB unit is manufactured through a non-radioactive process and then placed in a radiation field (typically a fission reactor) to convert a portion of a non-radioactive precursor material into an activated material (e.g., radioisotope) for charging. After charging, the CAB unit is ready for use and can be combined with additional CAB units into a CAB stack to achieve the desired activity and then integrated into a CAB pack or a product that uses the radioactivity for the desired application such as heating, electricity, and passive x-ray sources. The pre-irradiation encapsulation manufacturing method uses a die press and sintering process to produce the CAB unit with the precursor material fully encapsulated by the encapsulation material. During and after the charging process, the encapsulation material serves as a barrier, preventing release of the activated material release.

### CROSS-REFERENCE TO RELATED APPLICATIONS

This application claims priority to U.S. Provisional Pat. Application No. 62/971,898, filed on Feb. 7, 2020, titled “Chargeable Atomic Batteries (CABs) enabled by ceramic encapsulation and activation charging production methods enabling cost-effective and scalable radioisotope heaters, electric generators, and x-ray sources,” the entirety of which is incorporated by reference herein.

This application relates to International Application No. PCT/US2021/XXXXXX, filed on Feb. 7, 2021, titled “Chargeable Atomic Battery and Activation Charging Production Methods,” the entirety of which is incorporated by reference herein.

### TECHNICAL FIELD

The present subject matter relates to examples of a chargeable atomic battery (CAB), such as CAB unit(s), a CAB stack, and a CAB pack constructed of a generally non-radioactive isotope and methods for irradiating the CAB unit(s) via a particle radiation source, allowing the CAB to emit radiation remotely from the particle radiation source to provide emitted radiation energy.

### BACKGROUND

Conventional atomic batteries, sometimes referred to as nuclear batteries or radioisotope generators, typically include Plutonium-238 (Pu-238) or similar “special nuclear material” that can be utilized to manufacture a nuclear weapon. As the Pu-238 radioisotope decays, electricity can be generated from nuclear energy. However, mass commercialization of atomic batteries faces multiple key challenges, including: (1) safety; (2) technical/manufacturing; (3) regulatory framework compliance; and (4) marketability.

Radioisotopes for power production have been in use for nearly 60 years, for example, in the 1960′s-1980′s low power pacemakers were developed using Plutonium-238 and Promethium-147. When an actinide atom fissions, Strontium-90 is a common byproduct. Hence, the Soviet Union mass produced Strontium-90 by processing nuclear fuel and deployed over 1,500 Strontium-90 power units across the Earth and in space. The United States Navy also deployed Strontium-90. However, the Strontium-90 power units faced safety challenges. There have been multiple cases of significant radioactive material release from dilapidated and damaged power units produced by the Soviet Union. Today, power units like the ones produced by the Soviet Union are still a safety liability and are not under consideration as a viable commercial technology.

Following are some of the technical problems in the field of atomic batteries that currently impede commercialization. There is not a robust method of encapsulating and isolating nuclear material from environmental release. Challenges in production and the complexity of containing the nuclear material have also limited the application of atomic batteries. Traditional atomic battery solutions are based on high performance and prohibitively expensive Plutonium-238. The cost, necessarily controlled nature, and limited supply of Plutonium-238 prevent widespread commercial adoption to atomic batteries.

Because of safety concerns, demanding manufacturing requirements, and high regulation, the manufacture and deployment of atomic batteries with Plutonium-238 is complex. Production of Plutonium-238 requires a Neptunium-237 neutron irradiation target. Neptunium-237 is a man-made element that is a controlled special nuclear material. Only a small portion of Neptunium-237 target is converted with each irradiation cycle. This requires the use of chemical methods to dissolve and gather Plutonium-238 and requires significant radiation rated and secure facilities to produce Plutonium-238. Every step of the manufacturing process is closely monitored to ensure safety of human operators and the surrounding community of humans and other living organisms to avoid accidental radiation exposure. Every step is also monitored for national security purposes, in order to avoid unauthorized persons from acquiring special nuclear material. These concerns substantially limit the number of parties capable of manufacturing and transporting atomic batteries. Final recipients deploying the atomic battery, such as customers or other users, need to have in place security protocols to comply with regulations surrounding Plutonium-238, as well as any enrichment facilities needed to fuel or activate the atomic battery. Plutonium-238 is a high-performance atomic battery with a long successful history of deployment for government applications, however due to the issues stated above it cannot be deployed as a commercial technology and the cost of Plutonium-238 limits its use only to the most challenging problems.

Conventional atomic batteries, such as those that operate with Plutonium-238, contain none or very little of the seed material necessary for producing Plutonium-238 and instead use radiochemistry methods to gather the radioactive material. Hence, traditional atomic battery solutions are single-use (without a charging capability) - a radioactive fuel capsule emits subatomic particles, providing energy, until the radioactive material within the fuel capsule has substantially stabilized. Once stabilized, the radioactive material no longer emits enough energy, effectively ending the lifetime (duration of usefulness) of the atomic battery. Once depleted, traditional atomic batteries have similar waste concerns as the nuclear fuel of a nuclear reactor and must be secured and properly stored because of trace amounts of Plutonium-238 and other reactive materials left in the atomic battery.

Utilizing Plutonium-238 constrains the life of an atomic battery to a very specific period. Because Plutonium-238 has a half-life of approximately 88 years, optimizing the size and composition of a Plutonium-238-based atomic battery to a lifespan substantially shorter or longer than 44 years and maintaining consistent radiation output is difficult. Consequently, traditional atomic batteries may need to be retired from service early: after their relatively short mission has been completed, but long before the radioactive battery has substantially stopped emitting radiation. Generally, radioactive material will become inert after approximately 10-20 half-lives. This means that Plutonium-238 is a radiological safety concern for approximately one to two millennia. For shorter-term applications, this is not ideal and limits the utility of Plutonium-238.

Plutonium-238 within traditional atomic batteries emits primarily alpha particles. These alpha emissions have different applications and risk profiles as compared to, for example, beta and gamma particle emissions. Beta and gamma emissions generally penetrate further than alpha emissions, but the beta emissions are generally less damaging to living tissue when inhaled or ingested. Beta and gamma materials emit penetrating x-rays, which can be useful for certain use cases.

### SUMMARY

The various examples disclosed herein relate to nuclear technologies for a CAB 190, which can include a CAB unit 104, a CAB stack 200, and a CAB pack 300. The CAB unit 104, CAB stack 200, and CAB pack 300 are generally referred to as CAB technologies.

These CAB technologies are intended for use in locations without other sources of power, and in extreme environments where robust, long-lived operation is key. These locations include space, terrestrial, underground, and underwater. Relevant use cases for the CAB 190 include small satellites operating far from the sun, electronics on the moon attempting to survive the lunar night, underwater vehicles to explore the depths of the ocean, and low-power heat in remote regions, such as Canada, northern Europe, and Asia. CAB 100 can possess one-million times the energy density of state-of-the-art chemical batteries and fossil fuel and provide game-changing performance for the aforementioned use cases.

The CAB unit 104 is a standardized form factor and is enabled by a manufacturing process adapted for many different commercial radioisotopes. The CAB stack 200 is a device that can hold multiple CAB units 104A-N such that it can be adapted to meet different power needs for various use cases. The CAB pack 300 contains the atomic battery stack 200. CAB pack 300 can integrate a radioisotope specific and mission-specific components, such as an x-ray shield 301, thermal interface(s) 304 (e.g., conductive interface, heat pipe, or thermoelectrics 305), and an aeroshell 302 for accidental launch failure and re-entry in the case of missions traveling into orbit. The CAB pack 300 is designed to provide either heat or radiation as a general-purpose resource. Commercial customers can utilize these resources in their vehicles and missions for various purposes, such as electrical power generation, thermal heating, remote sensing, propulsion, sanitization, etc.

CAB 190 is designed to have superior safety attributes. As described in FIG. 5, a significant innovation of the CAB 190 is a CAB manufacturing method 500 that eases the production process and eliminates the need for expensive radiochemical processing. CAB manufacturing method 500 provides an intrinsic level of encapsulation that contains an activated material (radionuclide) 162 converted from the precursor material 159 against release into the environment. The CAB manufacturing method 500 is based upon a system with two distinct materials: (1) an encapsulation material 152; and (2) a precursor material 159. The encapsulation material 152 is designed to provide a barrier that fully contains a filling 112 formed of the precursor material 159 and any converted activated material 162 and decayed material 163. The filling 112 is initially not radioactive during the manufacturing process 416. The filling 112 is a stable compound, but when the precursor material 159 is exposed to a radiation field such as a particle radiation source 101, the precursor material 159 interacts with that radiation and a portion of the stable precursor material 159 is converted into radioactive activated material 162. This activation process is called “charging.”

After the charging of the CAB units 104A-F, there is a cooling down period, which is a short waiting period allowing any undesired short-lived radioisotopes to decay. After this time, the CAB units 104A-F are ready to be integrated with the CAB stack 200 and CAB pack 300. This integration is typically done inside a radiation hot cell due to x-rays generated by the activated material (radionuclide) 162. After integration, the CAB pack 300 can include a radiation shield (e.g., x-ray shield 301) and is safe to transport to a customer.

As described in FIG. 11, a pre-irradiation encapsulation manufacturing method 1100 can yield three different types of encapsulations with various degrees of redundant encapsulation, as shown in FIG. 8. An encapsulation wall 111 provides a single level of encapsulation. The filling 122 inside the encapsulation wall 111 can be comprised of pure precursor material 159. Alternatively, for a double level of encapsulation, the filling 112 can be a mixture of the precursor material 159 and the encapsulation material 152 designed to form a contiguous encapsulation matrix 150 that serves as a double level of encapsulation. For triple or more levels of encapsulation, the encapsulation matrix 150 mixture type encapsulation can be upgraded to include one or more coatings on the precursor kernel 153 to provide additional precursor encapsulation coatings 154-157, yielding three or more physical barriers focused on preventing the release of encapsulated activated material 162 in the filling 112.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A illustrates a chargeable atomic battery (CAB) that includes a CAB unit.

FIG. 1B is a cutaway view of the CAB unit of FIG. 1A.

FIG. 2A illustrates a CAB that includes a CAB stack and a top view of the CAB stack.

FIG. 2B is a cutaway view of the CAB stack of FIG. 2A containing a few dozen CAB units of FIGS. 1A-B.

FIG. 3 illustrates a CAB that includes a CAB pack, in which the CAB pack includes the CAB stack of FIGS. 2A-B, an ablative aeroshell, and an x-ray shield shown in a cutaway view.

FIG. 4 illustrates a CAB system that includes an irradiation capsule containing six CAB units of FIGS. 1A-B undergoing irradiation from subatomic (e.g., neutron) particles from a particle radiation source that is a fission nuclear reactor core.

FIG. 5 is a flowchart showing a CAB manufacturing method for producing a CAB.

FIG. 6 illustrates activation isotope production governing equations describing the activation of an activated material (radionuclide) from a precursor material.

FIG. 7 illustrates a reaction pathway table for several particle radiation activation pathways.

FIG. 8 depicts in a CAB encapsulation chart of three types of encapsulation techniques for the CAB units of FIGS. 1A-B compared to a traditional approach with no encapsulation.

FIG. 9A illustrates a precursor kernel with several precursor encapsulation coatings and a callout of a single atom of Thulium-169 of the precursor kernel.

FIG. 9B illustrates a neutron interacting with the Thulium-169 of the precursor kernel of FIG. 9A.

FIG. 9C illustrates the precursor kernel of FIG. 9B having absorbed a neutron and being converted into an activated material that is a radionuclide of Thulium-170.

FIG. 9D illustrates the activated material of FIG. 9C decaying into a stable decay material and emitting a beta particle that interacts with material around it to produce Bremsstrahlung x-ray radiation.

FIG. 10A illustrates a filling of the CAB unit of FIGS. 1A-B containing precursor material before any charging of the filling.

FIG. 10B illustrates the now charged filling of the CAB unit of FIG. 10A after being exposed to a particle radiation source that is a fission reactor neutron source.

FIG. 10C illustrates the filling of the CAB unit of FIG. 10B during operation, producing beta radiation, which goes onto produce heat that is converted to electricity in the thermoelectric power conversion system of a customer.

FIG. 10D illustrates a depleted filling of the CAB unit of FIG. 10C at the end of operational life.

FIG. 10E illustrates the filling of the CAB unit of FIG. 10D that is now fully depleted.

FIG. 11 is a flowchart of a pre-irradiation encapsulation manufacturing method.

Parts Listing

| | |
|---|---|
| 101 | Particle Radiation Source (e.g., Nuclear Reactor Core) |
| 101A-N | Particle Radiation Sources |
| 104A-N | CAB Units |
| 111A-N | Encapsulation Walls |
| 112 | Filling |
| 113A-N | Exterior Encapsulation Walls |
| 114A-N | Interior Encapsulation Walls |
| 150 | Encapsulation Matrix |
| 151A-N | Precursor Material Particles |
| 152 | Encapsulation Material |
| 153 | Precursor Kernels 153A-N |
| 154-157 | Precursor Encapsulation Coatings |
| 160A-N | Subatomic (e.g., Neutron) Particles |
| 162 | Activated Material or Radionuclide (e.g., Thulium-170) |
| 163 | Decayed Material |
| 164 | Interior Volume |
| 190 | Chargeable Atomic Battery |
| 192 | CAB System |
| 200 | CAB Stack |
| 211 | CAB Stack Housing |
| 212 | CAB Stack Lid |
| 300 | CAB Pack |
| 301 | X-Ray Shield |
| 302 | Aeroshell |
| 304 | Thermal Interface |
| 305 | Thermoelectrics |
| 402 | Irradiation Capsule |
| 500 | CAB Manufacturing Method |
| 600 | Activation Isotope Production Governing Equations |
| 700 | Reaction Pathway Table |
| 800 | CAB Encapsulation Chart |
| 801 | Type 1 (Wall) Encapsulation |
| 802 | Type 2 (Wall and Matrix) Encapsulation |
| 803 | Type 3 (Wall, Matrix, and Coating) Encapsulation |
| 805 | Type 0: No Encapsulation |
| 959 | Precursor Isotope/Atom |
| 962 | Activated Isotope/Atom |
| 963 | Decayed Isotope/Atom |
| 973A-N | Subatomic Decay (e.g., Beta) Particles |
| 974 | Subatomic Decay (e.g., Antineutrino) Particles |
| 975 | X-Ray Particle |
| 1100 | Pre-Irradiation Encapsulation Manufacturing Method |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, physical, or electrical connection. Unless described otherwise, coupled elements or devices are not necessarily directly connected to one another and may be separated by intermediate components, elements, etc.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ± 5% or as much as ± 10% from the stated amount. The term “approximately,” “significantly,” or “substantially” means that the parameter value or the like varies up to ± 25% from the stated amount.

The orientations of the chargeable atomic battery 190, associated components, and/or any chargeable atomic battery system 192 incorporating the chargeable atomic battery 190, CAB units 104A-G, CAB stack 200, CAB pack 300, or precursor material particles 151A-N, such as shown in any of the drawings, are given by way of example only, for illustration and discussion purposes. In operation for a particular chargeable atomic battery 190, the components may be oriented in any other direction suitable to the particular application of the chargeable atomic battery 190, for example upright, sideways, or any other orientation. Also, to the extent used herein, any directional term, such as lateral, longitudinal, up, down, upper, lower, top, bottom, and side, are used by way of example only, and are not limiting as to direction or orientation of any chargeable atomic battery 190 or component of the chargeable atomic battery 190 constructed as otherwise described herein.

The mass number of an element is denoted in two interchangeable formats. In one mass number format, the mass number is appended to the element name or symbol via a hyphen (e.g. Plutonium-238 or Pu-238). In a second mass number format, the mass number prepends the element name or symbol in superscript (e.g. ²³⁸Plutonium or ²³⁸Pu.) Both formats may appear in the same figures and associated detailed description paragraphs, and no special significance should be placed upon the use of a particular mass number format. Mixed mass number formats (e.g. figure elements labelled “Pu-238” with an associated detailed description paragraph reciting “²³⁸Plutonium”) does not indicate a special significance or relationship when compared to non-mixed mass number formats.

A chargeable atomic battery (CAB) 190 and a standardized pre-irradiation encapsulation manufacturing method 1100 to ease manufacturing and improve safety features. A CAB unit 104A is manufactured through a non-radioactive process and then placed in a radiation field of a particle radiation source 101, such as a fission nuclear reactor core 101 to convert a portion of a non-radioactive precursor material 159 into an activated material (radioisotope) 162. The radioisotope conversion process is called “charging.” After charging, the CAB unit 104A is ready for use and can be combined with additional CAB units 104B-N into a CAB stack 200 to achieve the desired activity and integrated into a CAB pack 300 or product, such as an independent device, that uses the radioactivity for the desired application such as heating, electricity, and passive x-ray sources. A pre-irradiation encapsulation manufacturing method 1100 uses a die press and sintering process to produce a CAB unit 104A with the precursor material 159 fully encapsulated by the encapsulation material 152. During and after the charging process, the encapsulation material 152 serves as a barrier, preventing release of the activated material 162.

FIG. 1A illustrates a CAB 190 that includes at least one CAB unit 104. The at least one CAB unit 104 includes an encapsulation material 152 and a precursor material 159. The precursor material 159 can be embedded within the encapsulation material 152. FIG. 1B is cutaway view of the CAB unit 104 of FIG. 1A

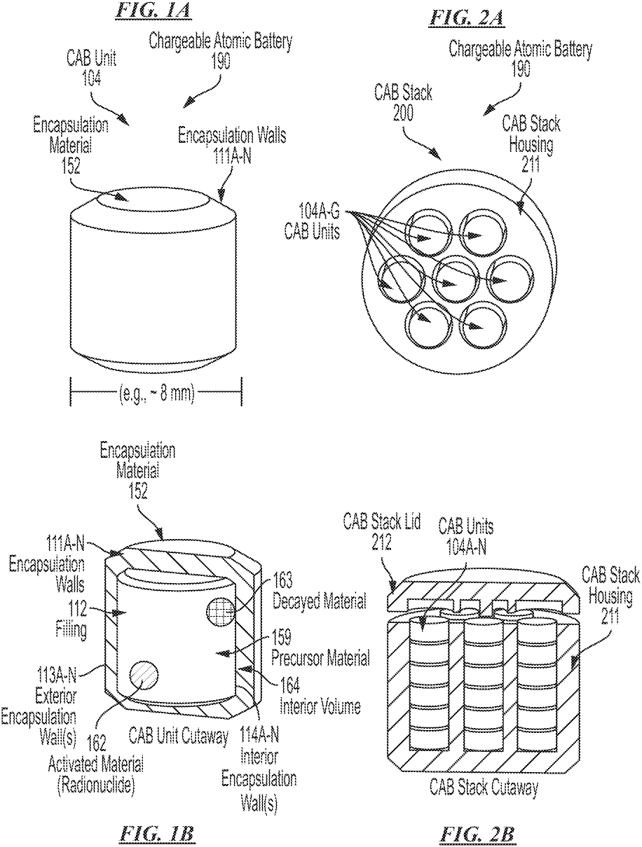

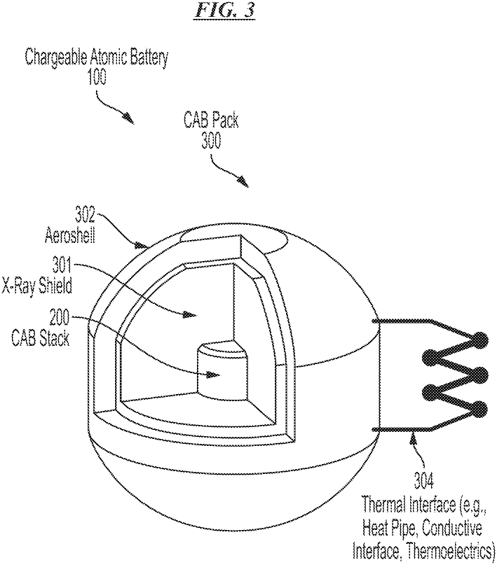

Notionally, the form factor of the CAB unit 104 is small as the CAB unit 104 is a basic unit that can be incremented by integrating multiple CAB units 104A-N into a CAB stack 200 as shown in FIG. 2. Additionally, the CAB unit 104 is a small form factor in the example because of limited space, self-shielding, and thermal constraints when charging in a particle radiation source 101. The CAB unit 104 can be approximately 8 mm in diameter, 8 mm in height, and with a 1 mm thick encapsulation wall 111, but designs can deviate significantly.

CAB unit 104 is initially manufactured with an encapsulation wall 111 formed of the encapsulation material 152 and a filling 112 formed of the precursor material 159 inside the encapsulation wall 111. CAB unit 104 provides an intrinsic safety case against accidental release of an activated material 162, eases handling and facility requirements, and provides a repeatable production pathway that can be applied to many different radioisotopes from various precursor material(s) 159 using a wide range of particle radiation sources 101A-N.

Precursor material 159 is a stable isotope. During an initial charging cycle of the CAB 190, a particle radiation source 101 converts a portion of the precursor material 159 into an activated material 162 that is an activation state. Accordingly, a charging method for the chargeable atomic battery 190 can include: (1) placing the CAB unit 104 in a radiation field of the particle radiation source 101; and (2) converting, via the particle radiation source 101, the precursor material 159 into the activated material 162.

The filling 112 formed of the precursor material 159 is convertible into the activation state, in which case a subset (fraction) or all of the precursor material 159 becomes activated material 162 upon being exposed to subatomic (e.g., neutron) particles 160A-N from a particle radiation source 101. The particle radiation source 101 converts the precursor material 159 into the activation material 162 that is in the activation state based on a reaction pathway. The particle radiation source 101 can be implemented like the nuclear reactor core described in FIG. 2C and the associated text of U.S. Pat. Pub. No. 2020/0027587 to Ultra Safe Nuclear Corporation of Seattle, Washington, published Jan. 23, 2020, titled “Composite Moderator for Nuclear Reactor Systems,” the entirety of which is incorporated by reference herein.

After charging a subset (fraction) or all of the precursor material 159 is converted into activated material 162, and eventually the activated material 162 decays into decayed material 163. A suitable encapsulation material 152 generally satisfies one or more of the following criteria: high temperature capable; chemically nonreactive during manufacturing, charging, and operation; mechanically strong; resistant to crack propagation, resistant to diffusion or any other means of transport of the activated material 162 through its grains or grain boundaries; resists significant degradation of material properties during irradiation and charging by the particle radiation source 101; favorable thermodynamic material properties such as thermal conductivity; and a low nuclear activation cross-section. This listing is not exhaustive, and there may be other criteria depending on the application.

Typically, the encapsulation material 152 does not activate into a radionuclide under irradiation from the particle radiation source 101. A possible exception is that some amount of short-lived radionuclides may be acceptable. After charging, CAB units 104A-N with short-lived activated material 162 can be placed temporarily in a storage site to allow the short-lived radionuclides to decay to negligible amounts. Two example materials are Aluminum and Silicon, which activate into Aluminum-28 and Silicon-31. However, these materials have short half-lives on the order of a few hours and will decay almost completely into stable isotopes.

Activated material 162 emits subatomic particles 160A-N through nuclear decay. The activated material 162 is a radionuclide, also referred to as a radioactive nuclide, radioactive isotope, or a radioisotope. The activated material 162 includes an alpha emitting isotope, a beta emitting isotope, a gamma emitting isotope, or a combination thereof. In a first example, the activated material 162 includes the beta emitting isotope that produces Bremsstrahlung radiation for a passive x-ray source. In a second example, the activated material 162 includes the gamma emitting isotope that directly produces high energy x-rays for a passive x-ray source.

In the example of FIGS. 1A-B, type 1 (wall) encapsulation 801 (see FIG. 8) is shown, in which the CAB unit 104 includes one more encapsulation walls 111A-N that encapsulate the filling 112. The filling 112 includes the precursor material 159 that converts into the activated material 162 upon irradiation by the particle radiation source 101. When initially manufactured and prior to the initial charging cycle, filling 112 can include either 100% precursor material 159 or additional encapsulation barriers, such as type 2 (wall and matrix) encapsulation 802 (see FIG. 8); or type 3 (wall, matrix, and coating) encapsulation 803 (see FIG. 8).

Precursor material 159 can be a filling 112 inside an interior volume (e.g., cavity) 164 formed of the encapsulation material 152, etc. A body that includes one or more encapsulation walls 111A-N can be formed of the encapsulation material 152. The encapsulation walls 111A-N include one or more exterior (e.g., outer) encapsulation walls 113A-N and one or more interior (e.g., inner) encapsulation walls 114A-N. The interior encapsulation walls 114A-N interface the filling 112 formed of the precursor material 159 (and activated material 162 if converted into the activation state and/or decayed material 163). Interior encapsulation walls 114A-N surround an interior volume 164 of the encapsulation material 152 that is filled with or lined with the precursor material 159 (and activated material 162 if converted into the activation state and/or decayed material 163). The one or more exterior encapsulation walls 113A-N and the interior encapsulation walls 114A-N can be continuous or discontinuous surfaces. The body of encapsulation walls 111A-N can be circular or oval shaped (e.g., a spheroid, cylinder, tube, or pipe). The body of encapsulation walls 111A-N can be square or rectangular shaped (e.g., cuboid) or other polygonal shape. The one or more interior encapsulation walls 114A-N of the encapsulation material 152 can be one continuous interior encapsulation wall 114 surrounding the filling 112 of the precursor material 159 (and activated material 162 if converted into the activation state and/or decayed material 163). Alternatively, the one or more interior encapsulation walls 114A-N formed of the encapsulation material 152 can be a plurality of discontinuous interior encapsulation walls 114A-N, which depend on the shape of the precursor material 159 filling the interior volume 164 of the encapsulation material 152. If the filling 112 of precursor material 159 is a spheroid in three-dimensional space, then there is one continuous interior encapsulation wall 114 of the encapsulation material 152 in the interior volume 164 surrounding the precursor material 159. If the filling 112 is a cuboid or polygonal shape in three-dimensional space, then there are a plurality of continuous interior encapsulation walls 114A-N of the encapsulation material 152 in the interior volume 164 surrounding the precursor material 159.

FIG. 2A illustrates a CAB 190 that includes a CAB stack 200 and a top view of the CAB stack 200. FIG. 2B is a cutaway view of the CAB stack 200 of FIG. 2A containing a few dozen CAB units 104A-N of FIGS. 1A-B. CAB stack 200 includes a plurality of the CAB units 104A-N and a CAB stack housing 211 designed to integrate the plurality of CAB units 104A-N into a single unit. The CAB stack housing 211 includes a high-temperature material to serve as an additional encapsulation barrier. In one example, the high-temperature material includes tungsten.

CAB stack 200 is a device to integrate many CAB units 104A-N together. As shown in FIG. 2B, the CAB stack 200 includes a CAB stack housing 211 and a CAB stack lid 212. The CAB stack housing 211 can hold 42 CAB units 104A-N. The CAB units 104A-N are placed inside the CAB stack housing 211, and then the CAB stack lid 212 can be attached 202 by threads, welding, etc. or some other method to form the CAB stack 200.

FIG. 3 illustrates a CAB 190 that includes a CAB pack 300. The CAB pack 300 includes the CAB stack 200 of FIGS. 2A-B, an ablative aeroshell 302, and an x-ray shield 301 shown in a cutaway view. Hence, in the example of FIG. 3, the CAB 190 is a space-bound x-ray emitting CAB 190. Generally, the CAB pack 300 integrates the CAB stack 200 with any other required components for either thermal, safety, x-ray, or other application requirements. Depending on the application requirements, the CAB pack 300 includes at least one of an x-ray shield 301, a thermal interface 304, or an aeroshell 302.

In FIG. 3, the CAB stack 200 is contained within the x-ray shield 301. The x-ray shield 301 includes a heavy metal to substantially block x-rays from leaving the CAB stack 200. The thermal interface 304 includes a conductive interface, a heat pipe, or a combination thereof and directs heat produced by the CAB stack 200 to the conductive interface, the heat pipe, or the combination thereof. Alternatively or additionally, the thermal interface 304 can include thermoelectrics 305, such as an array of thermocouples to convert the heat released by the decay of the precursor material 159 in a radioactive state (e.g., activation state) into electricity by the Seebeck effect. Aeroshell 302 includes an ablative material to protect the CAB stack 200 from high temperature reentry plasma erosion and release during travel. The x-ray shield 301, the thermal interface 304, or the aeroshell 302 provide additional encapsulation layer around the CAB stack 200.

CAB pack 300 can be placed within a product, such as an independent device. For example, the independent device may include the CAB pack 300 and use decay radiation, thermal heat, or a combination thereof for heating, production of electricity, x-ray fluorescence detection, sanitization, or propulsion.

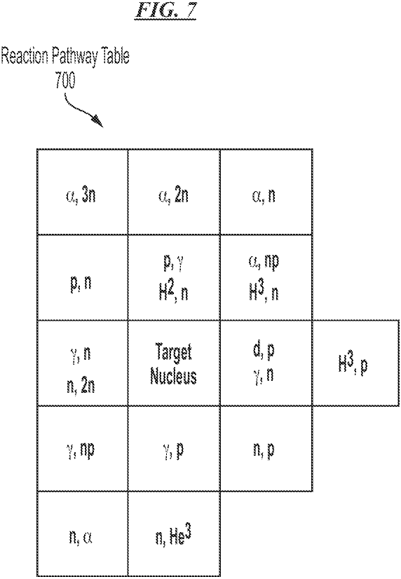

CAB unit 104 can be used to produce and contain high activity activated material 162 that can produce significant amounts of heat and or x-ray radiation that can be used for useful purposes. The CAB unit 104 can accommodate many different types of precursor material(s) 159 forming the filling 112 and activated material 162 if there is a reasonable production rate from the particle radiation activation pathways as described in FIGS. 6-7.

CAB unit 104 is compatible with various types of particle radiation particle sources 101A-N such ions in accelerators, high energy fusion neutrons, lower energy fission neutrons, spallation neutron sources, and high energy photon generators. The particle radiation source 101 penetrates the encapsulation wall 111 and into the filling 112 that includes the precursor material 159. Higher energy particle radiation sources 101A-N and neutral sources generally penetrate more deeply into the precursor material 159 and are more suitable for charging of the CAB unit 104 to produce activated material 412.

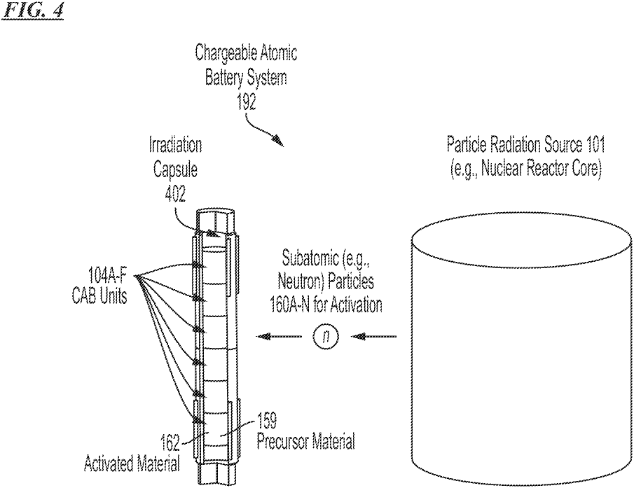

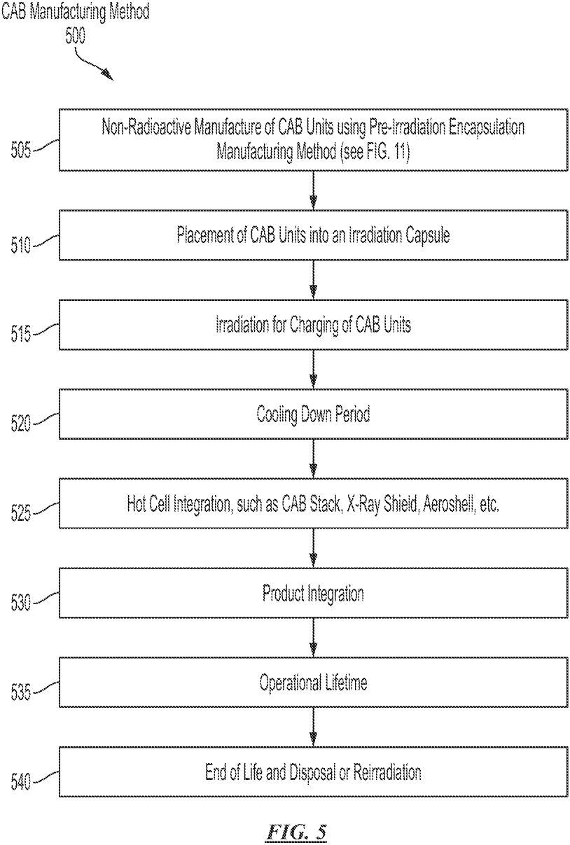

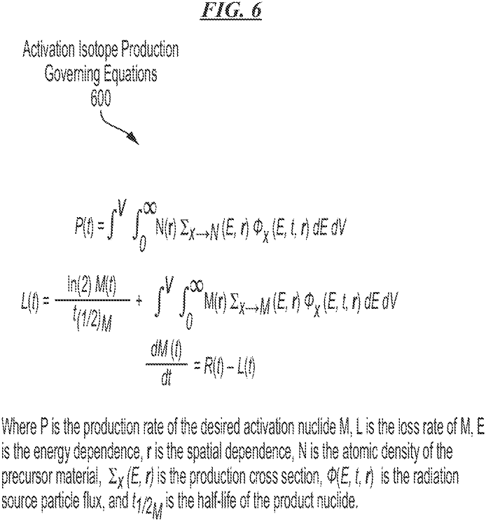

FIG. 4 illustrates a CAB system 192 that includes an irradiation capsule 402 containing six CAB units 104A-F of FIGS. 1A-B undergoing irradiation from subatomic (e.g., neutron) particles 160A-N from a particle radiation source 101 that is a fission nuclear reactor core 101. FIG. 5 is a flowchart showing a CAB manufacturing method 500 for a CAB 190. Beginning in step 505 of the CAB manufacturing method 500, CAB units 104A-F are fabricated using a pre-irradiation encapsulation manufacturing method 1100, which is described in FIG. 11. The pre-irradiation encapsulation manufacturing method 1100 of FIG. 11 produces uncharged CAB units 104A-F that are safe to handle.

Continuing to step 510 of the CAB manufacturing method 500, the CAB units 104A-F are placed inside of an irradiation capsule 402, as shown in FIG. 4. The irradiation capsule 402 can vary significantly depending on the type of the particle radiation source 101 that is used for charging, and the irradiation capsule 402 may not be required in some cases. The purpose of the irradiation capsule 402 is to isolate and integrate the CAB units 104A-F within the geometry of the particle radiation source 101 and provide a thermal radiation interface to cool the CAB units 104A-F as the CAB units 104A-F are charging.

Moving to step 515 of the CAB manufacturing method 500, irradiation capsule 402 is then placed within range of the particle radiation source 101 as shown in FIG. 4. The irradiation capsule is then irradiated by the subatomic particles 160A-N for activation, which converts a subset (fraction) or all of the precursor material 159 into an activated material 162. The desired irradiation time can be highly variable depending on the intensity of the particle radiation source 101, the cross section of the reaction, the half-life of the activated material 162, the cost of operation, possible damage to the CAB units 104A-F at higher radiation fluences, the amount of time the particle radiation source 101 can be active, and other parameters. Typically, only a subset of the precursor material 159 is activated for optimal production conditions.

Typically, the precursor material 159 and the encapsulation material 152 have some atomic impurities from the material supply and possibly from additives or inclusions during the pre-irradiation encapsulation manufacturing method 1100 of FIG. 11. These impurities are evaluated for the impact upon the CAB units 104A-F, especially during irradiation for charging when some of the impurities may interact with the particle radiation source 101 to produce undesirable radioisotopes.

Continuing now to step 520 of the CAB manufacturing method 500, the CAB units 104A-F inside the irradiation capsule 402 enter a cooling down period, in which the CAB units 104A-F do not undergo further irradiation from the subatomic particles 160A-N. The CAB units 104A-F remain inside the irradiation capsule 402 and are not handled during the cooling down period. Typically, there are some short-lived radioisotopes produced from the precursor material 159 during the charging process of the CAB units 104A-F. Some of these short-lived radioisotopes are from impurities within the CAB units 104A-F, and others are from low yield cross-section paths. It is usually advantageous to allow the CAB units 104A-F to have these short live isotopes to decay or “cool down” before opening the irradiation capsule 402.

Moving to step 525 of the CAB manufacturing method 500, after the cooling down period, the irradiation capsule 402 is moved to a hot cell, and the CAB units 104A-F are integrated into a CAB stack 200, CAB pack 300, etc. A hot cell is a shielded room with remotely operated manipulators. The irradiation capsule 402 is then opened and the CAB units 104A-F are removed. The CAB units 104A-F are then quality checked and integrated into the CAB stack housing 211 of the CAB stack 200 and the CAB stack lid 212 is closed. The CAB stack 200 also provides an additional layer of encapsulation and is manufactured from a high-temperature material that is mechanically strong, such as Tungsten for superior mechanical resistance.

The CAB pack 300 is a device that integrates the CAB stack 200 with any other required components for either thermal, safety, x-ray, or other application requirements. For an activated material 162 that produces x-rays, the CAB pack 300 can integrate an x-ray shield 301. This x-ray shield 301 is typically formed of a heavy metal for mass sensitive applications, but x-ray shield 301 can also be formed of almost any material for applications where higher mass is not an issue. The x-ray shield 301 is attached to the CAB pack 300 and is now safe for limited handling and can be taken out of the hot cell if desired. For an activated material 162 that does not produce x-rays or other penetrating radiation, no x-ray shield 301 is required.

For applications where thermal heat is produced in significant quantities, the CAB pack 300 can include a thermal interface 304, which can include thermal distribution devices, such as conductive interfaces or heat pipes. For applications where launch into space is required, the CAB pack 300 can integrate an aeroshell 302.

Moving to step 525 of the CAB manufacturing method 500, after hot cell integration, the CAB pack 300 is ready for product integration with an independent device. Product integration involves integrating the thermal interface 304 of the CAB pack 300 to a use application, for example, connecting the thermal interface 304 with a thermoelectric generator or other independent device for power production. Another example is integrating the CAB pack 300 with an independent device that can take the heat from the CAB pack 300 into a fluid for propulsion. The implementation of the product integration can be widely varied. In addition to the product integration, licensing the product may be required. When the precursor material 159 is converted into activated material (radionuclide) 162 during charging, the CAB units 104A-F are likely subject to user licenses from the national/federal, state, or local agencies depending on the location, use case, and other factors.

In step 535 of the CAB manufacturing method 500, after the CAB pack 300 is integrated with the product, the CAB pack 300 can then be deployed on a mission. The CAB pack 300 faithfully produces radiation or heat according to a half-life of the activated material 162, and the independent device is able to use these resources to accomplish the mission.

Finishing in step 540 of the CAB manufacturing method 500, after some amount of time, the activated material 162 in the CAB units 104A-F of the CAB pack 300 decay to a point where the independent device will no longer receive enough heat or radiation from the CAB pack 300. This is typically 1-5 half-lives, but can be much longer. The CAB pack 300 can be disposed of at this point, but would still be considered radioactive. Between 10-20 half-lives, the activated material 162 of the CAB pack 300 will have decayed into the decayed material 163 such that the CAB pack 300 is no longer considered radioactive and can be safely handled and easily disposed of.

In some cases, the CAB units 104A-F may be able to be re-irradiated or “recharged” to convert more of the precursor material 159 into the activated material 162. This may have practical value in certain situations where the half-life of the activated material 162 is short, there is an easily accessible particle radiation source 101, and the properties of the encapsulation material 152 are not limited to one charge cycle. If these criteria are met, then the CAB units 104A-F can be subject to many recharge cycles after an initial charging cycle. Eventually, after some number of charge cycles, all of the precursor material 159 is converted into the activated material 162, then the activated material 162 decays into the decayed material 163 and the CAB units 104A-F are no longer able to be recharged.

FIG. 6 illustrates activation isotope production governing equations 600 describing the activation of an activated material (radionuclide) 162 from a precursor material 159. The production rate (P) is the product of a nuclear cross-section, the flux of the particle radiation source 101, and a density of precursor material 159. In addition to a high production rate (P), a reasonable loss rate (L) is achieved. The half-life of the activated material 162 produced is sufficiently long for production and after production to last long enough for the use case of the CAB unit 104. During charging, the activated material 162 is converted from the precursor material 159 and may occasionally become double activated. This is usually undesirable as double conversion reduces the amount of the desired activated material 162 and introduces a new isotope typically with a half-life that is much shorter or much longer than desired for the CAB unit 104.

FIG. 7 illustrates a reaction pathway table 700 for several particle radiation activation pathways. Through the reaction pathways, the precursor material 159 is convertible into an activated state, generally as an activated material 162 via atomic irradiation by some particle radiation source 101.

FIG. 8 depicts in a CAB encapsulation chart 800 of three types of encapsulation techniques for the CAB units 104A-N of FIGS. 1A-B compared to a traditional approach with no encapsulation. CAB encapsulation chart 800 shows, in great detail, the three different filling configurations of: type 1 (wall) encapsulation 801, type 2 (wall and matrix) encapsulation 802, and type 3 (wall, matrix, and coating) encapsulation 803. Type 1 encapsulation 801 is comprised fully of encapsulation wall(s) 113A-N formed of the encapsulation material 152 around a filling 112 of the precursor material 159. Type 2 encapsulation 802 is comprised of an encapsulation matrix 150 that is a continuous matrix formed of encapsulation material 152 fully surrounding a small precursor kernel(s) 153A-N of precursor material 159. Type 3 encapsulation 803 is like type 2 encapsulation 802, but includes precursor encapsulation coatings 154-157 of encapsulation material 152 surrounding the precursor kernel(s) 153A-N formed as precursor material particles 151A-N. The encapsulation material 152 may include one or more distinct materials. For example, the wall, matrix, and coating encapsulation can be composed of different chemical compounds, but are collectively referred to as being formed of encapsulation material 152. In the type 0 (radioisotope only) traditional approach 805, there is no encapsulation and no precursor material 159, just a radionuclide that is not encapsulated.

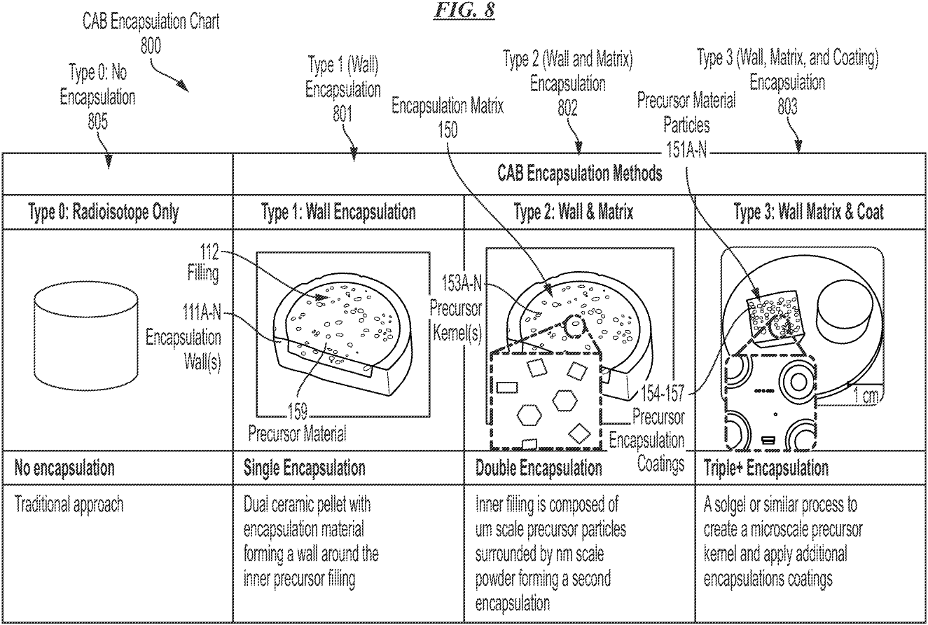

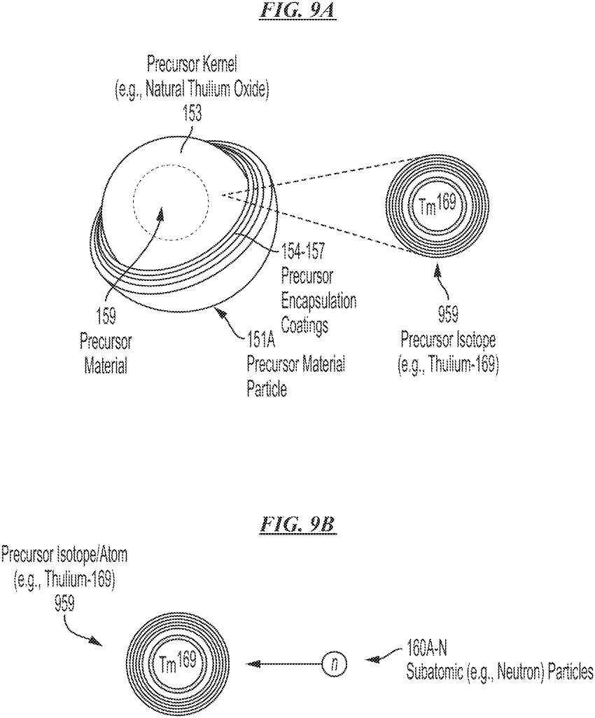

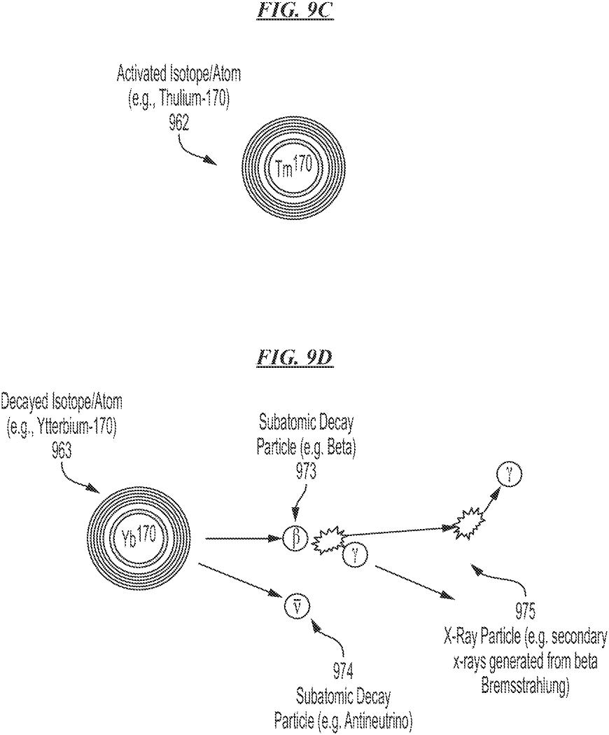

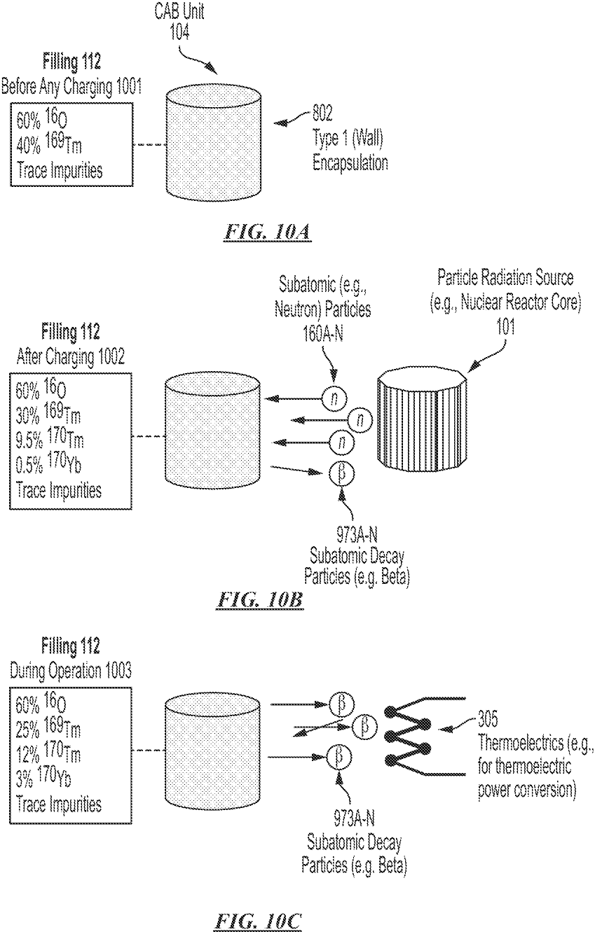

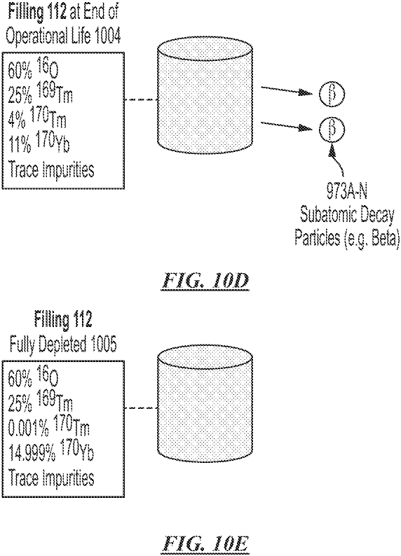

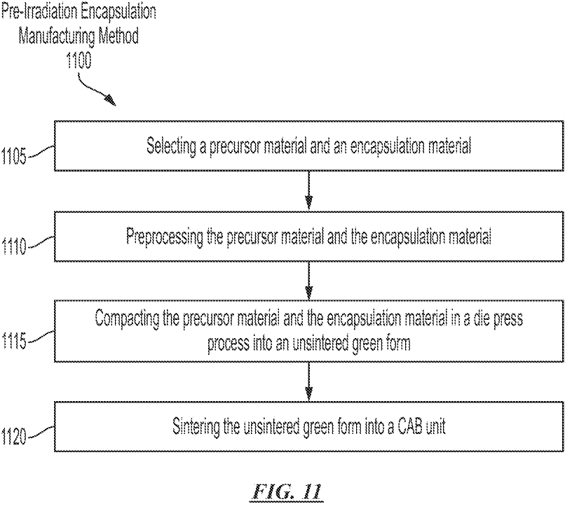

In the case of multiple encapsulation materials, such as type 2 (wall and matrix) encapsulation 802 and type 3 (wall, matrix, and coating) encapsulation 803 if the encapsulation walls 111A-N have negligible activation, the encapsulation matrix 153 and precursor encapsulation coatings 154-157 can have some activation as long as they serve a function as shown in FIGS. 9A-10E. As a purely illustrative example, Iron will activate in a low yield cross-section to produce the radioisotope Fe-55. However, Iron may, for example, provide a structural benefit and could be included in the encapsulation matrix 153 or precursor encapsulation coatings 154-157 to improve the safety features of the CAB unit 104.

FIG. 9A illustrates a precursor kernel 153 with several precursor encapsulation coatings 154-157 and a callout of a single atom of precursor isotope 959 (Thulium-169) from the precursor kernel 153. When initially manufactured, the precursor kernel 153 can be comprised entirely of the precursor material 159 or comprised of a mixture of precursor material 159 and encapsulation material 152. The precursor material 159 is focused upon an isotopic concentration of a desirable isotope, shown as precursor isotope 959 (Thulium-169). The precursor isotope 959 is an isotope that is part of a precursor element. In FIG. 9A, precursor kernel 153 includes the precursor element and is composed of one or more isotopes, and typically, only one isotope will have the desired radionuclide production pathway. A precursor element can be enriched if desired to have a greater proportion of the desired isotope or remove isotopes with an undesirable radionuclide production pathway. The enrichment process is not always necessary and, in some cases, even a very small amount of the precursor isotope 959 can be effective and even desirable for high cross-section precursor isotopes that could suffer from significant self-shielding.

The precursor kernel 153 can be composed of precursor isotope 959, activated isotope 962, decayed isotope 963, and non-interacting isotopes. The non-interacting isotopes include atoms, such as carbon and oxygen to chemically stabilize the materials, for example, the Oxygen in Thulium Oxide.

As shown, precursor kernel 153 is in a chemical format such as a metal, oxide, carbide, nitride, or other material of interest, which may contain additional atoms. An example of a precursor kernel 153 is Natural Thulium Oxide. The chemical form of the precursor kernel 153 in a CAB 190 can be chosen for compatibility with the pre-irradiation encapsulation manufacturing method 1100, chemical compatibility with encapsulation material 152, high-temperature capability, mechanical properties, thermodynamic properties, and other needs.

FIG. 9B illustrates a subatomic (e.g., neutron particles) 160A-N interacting with the precursor isotope 959 (Thulium-169). When placed into a particle radiation source 101, the CAB unit 104 begins to activate or convert the precursor isotope 959 into the activated isotope 962 (Thulium-170).

FIG. 9C illustrates the precursor isotope 959 (Thulium-169) of FIG. 9B having absorbed a neutron and being converted into an activated isotope 962 (Thulium-170).

FIG. 9D illustrates the activated isotope 962 of (Thulium-170) of FIG. 9C decaying into a decayed isotope 963 of stable decayed material 163 (Ytterbium-170 isotope) and emitting subatomic decay particles 973, 974. As shown, the activated atom 962 eventually decays according to its half-life. A half-life is the amount of time on average that half of the atoms would decay from a material. When an activated isotope 962 decays, it will emit radiation and decay into a lower energy state. Typically, the lower energy state is stable. However, sometimes the lower energy state will still be radioactive and follow a decay process once again in a process known as a decay chain. The radiation emitted can be in the cases of an alpha emitter or low energy beta emitter only travel a short distance and be contained within the CAB unit 100. However, gamma emitters and higher energy beta particles will ultimately produce x-rays that can travel outside of the CAB unit 104. In many cases, the generation of penetrating radiation necessitates the need for radiation shielding 303, such as the x-ray shield in FIG. 3.

As shown, subatomic decay particle 973 is a beta decay particle and subatomic decay particle 974 is an antineutrino that interacts with material around, such as to produce Bremsstrahlung x-ray particle 975 radiation. The activated atom 962 (Thulium-170 isotope) decays into decayed atom 963 (Ytterbium-170 isotope), emitting the beta particle 973 and an antineutrino 974. The antineutrino 974 is a weakly interacting material with no future impact; however, the beta particle 973 is a high energy electron. The beta particle 973 itself can only travel a short distance (on the order of 10s to 100 s of micrometers); the beta particle 973 will interact with nearby atoms to generate x-rays 974 through a process known as Bremsstrahlung. The decayed atom 963 (Ytterbium-170) is a stable non-radioactive atom known as a decayed atom or, at a larger scale, a decayed material.

FIG. 10A illustrates the filling 112 of the CAB unit 104 of FIGS. 1A-B containing precursor material 159 before any charging 1001 occurs. The filling 112 implements a type 1 (wall) encapsulation 802 with a Thulium Oxide precursor material 159. FIG. 10B illustrates the filling 112 of the CAB unit 104 of FIG. 10A after charging 1002 and being exposed to a particle radiation source 101 that is a fission reactor neutron source. The precursor material 159 interacts with neutrons from a fission power source and has converted one out of every four of the precursor isotope 959 (Thulium-169) into the activated isotope 962 (Thulium-170). During the charging process, some fraction of the Thulium-170 will have decayed into decayed isotope 963 (Ytterbrium-170).

FIG. 10C illustrates the filling 112 of the CAB unit 104 of FIG. 10B during operation 1003 producing subatomic decay particles 973A-N (beta radiation 973) that goes onto produce heat that is converted to electricity in a thermoelectric 305 power conversion system of a customer. After charging, the CAB unit 104 is integrated into the CAB stack 200 and CAB pack 300. In FIG. 10C, the CAB unit 300 is integrated with a thermoelectric 305 power conversion system to create electricity. During this time, significant amounts of activated material 162 (Thulium-170) will decay into decayed material 163 (Ytterbrium-170) according to the roughly 4-month half-life, and the beta decay rate and concomitant thermal power production will drop.

FIG. 10D illustrates a depleted filling 112 of the CAB unit 104 of FIG. 10C at the end of operational life 1004. At some time in the future, the decayed material 163 (Ytterbrium-170) will have decayed to the point where its thermal power output will be too small to be useful, and the device will have reached end of operational life 1004.

FIG. 10E illustrates the filling 112 of the CAB unit 104 of FIG. 10D that is now fully depleted 1005. Despite the CAB unit 104 of FIG. 10D being at the end of its operational life, there is still a significant inventory of activated Thulium-170. After approximately 4 years after end of operation (or approximately 12 half-lives) the activated material (radionuclide) 162 will have decayed by a factor of 2¹² or 4096 and the inventory of Thulium-170 has dropped nearly to zero. At this point, the CAB unit 104 can be considered fully depleted.

It is generally desirable to have the activated material 162 to have a half-life close to the mission length. A long mission using a short half-life radioisotope of activated material 162 would run out of power. A short mission using a long half-life radioisotope would be a waste of resources and may need to be safely stored. Traditional Plutonium-238 atomic batteries have an 87-year half-life. For a hypothetical 1-year short mission, Plutonium-238 is not well-utilized. For multi-decade missions to the outer planets, Plutonium-238 has an excellent half-life match.

A key innovation of the CAB technology is that a CAB 190 can be tailored to meet certain mission needs. The precursor isotope 959 can be chosen (based on the half-life of the activated material 162) to meet the lifetime requirement of the mission. The power level of the CAB pack 300 can be modified both by the choice of precursor material 159 and the stacking arrangement in the CAB stack 200. If a mission has tolerance requirements for x-ray radiation 975, either a heavier x-ray shield 301 can be attached, or an activated material 162 can be chosen that emits fewer x-rays 975. The design of the CAB unit 104 can be tailored to meet the needs of a mission; for example a space mission can include an aeroshell 302 to mitigate the damaging effects of plasma encountered during reentry into the atmosphere from orbital velocities. For space missions, the aeroshell 302 can be important as a safety feature in case of a rocket launch failure to prevent burnup and dispersal of radionuclides of activated material 162 in that scenario. For missions where high temperature tolerance is a requirement, precursor material 159 and encapsulation material 152 can be selected to meet those requirements. This list is not exhaustive and there are many addition ways to customize a CAB pack 300 to meet the mission requirements.

FIG. 11 is a flowchart of a pre-irradiation encapsulation manufacturing method 1100 for a CAB 190. Beginning in step 1105, the pre-irradiation encapsulation manufacturing method 1100 includes selecting (and optionally sourcing) a precursor material 159 and an encapsulation material 152. The precursor material 159 and the encapsulation material 152 are procured in powder formats. Significant research goes into understanding the power morphology and chemical interactions of the precursor material 159 and the encapsulation material 152 to make sure the materials will be chemically and mechanically compatible during the later stages of production while meeting the other fundamental functions of the precursor material 159 and the encapsulation material 152. The step 1105 of selecting the precursor material 159 and the encapsulation material 152 can be based on a respective activation cross-section, a respective particle source irradiation dependent mechanical property, a respective chemical compatibility, a respective high temperature capability, a respective powder property, or a combination thereof.

Continuing to step 1110, the pre-irradiation encapsulation manufacturing method 1100 further includes preprocessing the precursor material 159 and the encapsulation material 152. For example, the powders of the precursor material 159 and the encapsulation material 152 can sometimes require preprocessing by adjusting the grain size using techniques, such as milling and sieving. Calcination may be required to react the powders. Inclusions may be desirable as binding agents. Sol-gel processes may be utilized. Coatings can be applied to powder kernels. There are many other kinds of powder process techniques that may be utilized depending on the needs of the precursor material 159 and the encapsulation material 152.

Some of these operations may be implemented in a fume hood or glove box to safely meet material handling requirements, especially those involved in handling nano-powders and micro-powders. Hence, the step 1110 of preprocessing the precursor material 159 and the encapsulation material 152 includes applying a power processing technique. The power processing technique includes calcination, milling, sieving, or a combination thereof to obtain a desired powder morphology.

In an example, the step 1110 of preprocessing the precursor material 159 and the encapsulation material 152 includes coating the precursor material 159 with one or more precursor encapsulation coatings (e.g., layers) 154-157 formed of the encapsulation material 152 to provide a third level or more of encapsulation.

Moving to step 1115, the pre-irradiation encapsulation manufacturing method 1100 further includes compacting the precursor material 159 and the encapsulation material 152 in a die press process into an unsintered green form, which can be a multi-component green form. The die press process takes the powders of the precursor material 159 and the encapsulation material 152 and compacts the powders. Specialized dies, and multi-step press processes can be implemented to make the multi-component pressed powder compacts, called “green forms,” to achieve the encapsulation types 801-803 described in FIG. 8.

In a first example, the encapsulation material 152 includes an encapsulation wall material. The step 1115 of compacting the precursor material 159 and the encapsulation material 152 in the die press process into the unsintered green form includes producing an encapsulation wall 111 formed of the encapsulation wall material to provide a first encapsulation. In a second example, the step 1115 of compacting the precursor material 159 and the encapsulation material 152 in the die press process into the unsintered green form further includes filling inside the encapsulation wall 111 with the precursor material 159.

In a third example, the encapsulation material 152 includes an encapsulation matrix material. The step 1110 of preprocessing the precursor material 159 and the encapsulation material 152 further includes producing a mixture of the precursor material and the encapsulation matrix material. The mixture of the precursor material 159 and the encapsulation matrix material is a contiguous matrix of the encapsulation matrix material that fully encapsulates the precursor material 159. The step 1115 of compacting the precursor material 159 and the encapsulation material 152 in the die press process into the unsintered green form includes filling inside the encapsulation wall 111 with the mixture of the precursor material 159 and the encapsulation matrix material to form an encapsulation matrix 150 to provide a second encapsulation. In a fourth example, the step 1110 of preprocessing the precursor material 159 and the encapsulation material 152 includes coating the precursor material 159 with one or more precursor encapsulation coatings 154-157 formed of the encapsulation material 152 to provide a third level or more of encapsulation.

Finishing in step 1120, the pre-irradiation encapsulation manufacturing method 1100 further includes sintering the unsintered green form into a CAB unit 104. After creating the unsintered green form for the CAB unit 100, sintering occurs. The sintering process can be achieved through many different methods, such as spark plasma sintering, hot pressing, hot isostatic pressing, and furnaces. In some cases, an inert gas or air may be used.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain,” “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A chargeable atomic battery (CAB), comprising:
at least one CAB unit, wherein the at least one CAB unit includes:
an encapsulation material; and
a precursor material embedded within the encapsulation material.

2. The chargeable atomic battery of claim 1, wherein:
during an initial charging cycle of the chargeable atomic battery, a particle radiation source converts a portion of the precursor material into an activated material that is an activation state.

3. The chargeable atomic battery of claim 2, wherein:
the activated material emits subatomic particles through nuclear decay.

4. The chargeable atomic battery of claim 2, wherein:
the particle radiation source converts the precursor material into the activation material that is in the activation state based on a reaction pathway.

5. The chargeable atomic battery of claim 2, wherein:
the precursor material is a stable isotope; and
the activated material is a radionuclide.

6. The chargeable atomic battery of claim 5, wherein:
the radionuclide includes an alpha emitting isotope, a beta emitting isotope, a gamma emitting isotope, or a combination thereof.

7. The chargeable atomic battery of claim 6, wherein, in the activation state, the activated material includes the beta emitting isotope , the gamma emitting isotope, or the combination thereof.

8. The chargeable atomic battery of claim 6, wherein:
the activated material includes the beta emitting isotope that produces Bremsstrahlung radiation for a passive x-ray source.

9. The chargeable atomic battery of claim 7, wherein:
the activated material includes the gamma emitting isotope that directly produces high energy x-rays for a passive x-ray source.

10. A charging method for the chargeable atomic battery of claim 2, comprising steps of:
placing the chargeable atomic battery unit in a radiation field of the particle radiation source; and
converting, via the particle radiation source, the precursor material into the activated material.

11. A chargeable atomic battery stack, comprising:
a plurality of the CAB units of claim 1; and
a CAB stack housing designed to integrate the plurality of CAB units into a single unit.

12. The chargeable atomic battery stack of claim 11, wherein:
the CAB stack housing includes a high-temperature material to serve as an additional encapsulation barrier.

13. The chargeable atomic battery stack of claim 12, wherein:
the high-temperature material includes tungsten.

14. A chargeable atomic battery pack, comprising:
the chargeable atomic battery stack of claim 11; and
at least one of:
an x-ray shield,
a thermal interface, or
an aeroshell.

15. The chargeable atomic battery pack of claim 14, further comprising the x-ray shield, wherein:
the chargeable atomic battery stack is contained within the x-ray shield; and
the x-ray shield includes a heavy metal to substantially block x-rays from leaving the chargeable atomic battery stack.

16. The chargeable atomic battery pack of claim 14, further comprising the thermal interface, wherein:
the thermal interface directs heat produced by the chargeable atomic battery stack to a conductive interface, a heat pipe, or a combination thereof.

17. The chargeable atomic battery pack of claim 14, further comprising the aeroshell, wherein:
the aeroshell includes an ablative material to protect the chargeable atomic battery stack from high temperature reentry plasma erosion and release during travel.

18. The chargeable atomic battery pack of claim 14, wherein:
the x-ray shield, the thermal interface, or the aeroshell provide additional encapsulation layer around the chargeable atomic battery stack.

19. An independent device, comprising: the chargeable atomic battery pack of claim 14, wherein:
the chargeable atomic battery pack is placed within the independent device; and
the independent device uses decay radiation, thermal heat, or a combination thereof for heating, production of electricity, x-ray fluorescence detection, sanitization, or propulsion.

20. A pre-irradiation encapsulation manufacturing method for the chargeable atomic battery of claim 1, comprising steps of:
selecting the precursor material and the encapsulation material;
preprocessing the precursor material and the encapsulation material;
compacting the precursor material and the encapsulation material in a die press process into an unsintered green form; and
sintering the unsintered green form into the at least one CAB unit.

21. The pre-irradiation encapsulation manufacturing method of claim 20, wherein:
the step of selecting the precursor material and the encapsulation material is based on a respective activation cross-section, a respective particle source irradiation dependent mechanical property, a respective chemical compatibility, a respective high temperature capability, a respective powder property, or a combination thereof.

22. The pre-irradiation encapsulation manufacturing method of claim 20, wherein:
the step of preprocessing the precursor material and the encapsulation material includes applying a power processing technique;
the power processing technique includes calcination, milling, sieving, or a combination thereof to obtain a desired powder morphology.

23. The pre-irradiation encapsulation manufacturing method of claim 21, wherein:
the encapsulation material includes an encapsulation wall material; and
the step of compacting the precursor material and the encapsulation material in the die press process into the unsintered green form includes producing an encapsulation wall formed of the encapsulation wall material to provide a first encapsulation.

24. The pre-irradiation encapsulation manufacturing method of claim 23, wherein:
the step of compacting the precursor material and the encapsulation material in the die press process into the unsintered green form further includes filling inside the encapsulation wall with the precursor material.

25. The pre-irradiation encapsulation manufacturing method of claim 23, wherein:
the encapsulation material includes an encapsulation matrix material; and
the step of preprocessing the precursor material and the encapsulation material further includes producing a mixture of the precursor material and the encapsulation matrix material; and
the step of compacting the precursor material and the encapsulation material in the die press process into the unsintered green form includes filling inside the encapsulation wall with the mixture of the precursor material and the matrix encapsulation material to form an encapsulation matrix to provide a second encapsulation.

26. The pre-irradiation encapsulation manufacturing method of claim 25, wherein:
the mixture of the precursor material and the encapsulation matrix material is a contiguous matrix of the encapsulation matrix material that fully encapsulates the precursor material.

27. The pre-irradiation encapsulation manufacturing method of claim 25, wherein:
the step of preprocessing the precursor material and the encapsulation material includes coating the precursor material with one or more precursor encapsulation coatings formed of the encapsulation material to provide a third level or more of encapsulation.

28. The chargeable atomic battery of claim 1, wherein:
the precursor material includes Neptunium-237.
